(19) United States
(12) Patent Application Publication
(10) Pub. No.: US 2016/0180569 A1
(43) Pub. Date: Jun. 23, 2016

(54) IMAGE CREATION METHOD, A COMPUTER-READABLE STORAGE MEDIUM, AND AN IMAGE CREATION APPARATUS

(71) Applicant: CASIO COMPUTER CO., LTD., Tokyo (JP)

(72) Inventor: Nobuhiro Aoki, Tokyo (JP)

(21) Appl. No.: 14/972,446

(22) Filed: Dec. 17, 2015

(30) Foreign Application Priority Data
Dec. 22, 2014 (JP) 2014-259356

(51) Int. Cl. G06T 13/40; G06T 11/60; G06K 9/00

(52) U.S. Cl. CPC G06T 13/40; G06K 9/00302; G06T 11/60

(57) ABSTRACT

An image capture apparatus includes an original image acquisition unit, a facial image creation unit, a theme decision unit, a face part replacement unit, and an animation character image creation unit. The original image acquisition unit acquires an original image as a target for processing. The facial image creation unit creates a facial image based on a characteristic region of the original image. The theme decision unit decides a theme. The facial image creation unit changes the facial image based on the theme. The animation character image creation unit creates a pose image corresponding to the facial image based on the theme. Furthermore, the animation character creation unit composites a facial image changed by the face part replacement unit with a pose image created by the animation character image creation unit so as to create an animation character image.

This application is based upon and claims the benefit of priority from the prior Japanese Patent Application No. 2014-259356, filed Dec. 22, 2014, and the entire contents of which are incorporated herein by reference.

### BACKGROUND OF THE INVENTION

1. Field of the Invention

The present invention relates to an image creation method, a computer-readable storage medium, and an image creation apparatus.

2. Related Art

Conventionally, there has been a technology for creating an animation image from the picture of a face. For example, Japanese Unexamined Patent Application, Publication No. 2005-092657 discloses a technology for changing facial expressions by respectively changing a plurality of parts constituting a face.

### SUMMARY OF THE INVENTION

However, there has been a problem in that the abovementioned technology disclosed in Japanese Unexamined Patent Application, Publication No. 2005-092657 is not adequate for the use via an application or the like of a smartphone since the data volume becomes great in order to change facial expressions by changing the respective facial parts.

The present invention was made by considering such a situation, and it is an object of the present invention to create animation character images that express various expressions of animation characters with less data volume.

An image creation method executed by a control unit, including the steps of: creating a not-actually-photographed face image of a face based on an actually-photographed image including the face acquired; changing at least one not-actually-photographed partial image among a plurality of not-actually-photographed partial images which respectively correspond to a plurality of partial regions of the not-actually-photographed face images among the not-actually-photographed face images, to a not-actually-photographed subject image corresponding to a subject, based on the subject; and creating a composite image in which a body image which is an image of a body other than the face based on the subject is composited with the not-actually-photographed face image that was changed to the not-actually-photographed subject image.

### BRIEF DESCRIPTION OF THE DRAWINGS

FIG. 1 is a block diagram illustrating a hardware configuration of an image capture apparatus according to an embodiment of the present invention;

FIG. 2 is a view for explaining a method of creating an animation character image according to the present embodiment;

FIG. 3 is a view illustrating a comparative example of an animation character image in a case of creating with a different person;

FIG. 4 is a functional block diagram showing a functional configuration for executing animation character image creation processing, among the functional configurations of the image capture apparatus of FIG. 1;

FIG. 5 is a schematic view for explaining a theme table stored in a theme table storage unit; and

FIG. 6 is a flowchart illustrating a flow of animation character image creation processing executed by the image capture apparatus of FIG. 1 having the functional configurations of FIG. 4.

### DETAILED DESCRIPTION OF THE INVENTION

Embodiments of the present invention are explained below with reference to the drawings.

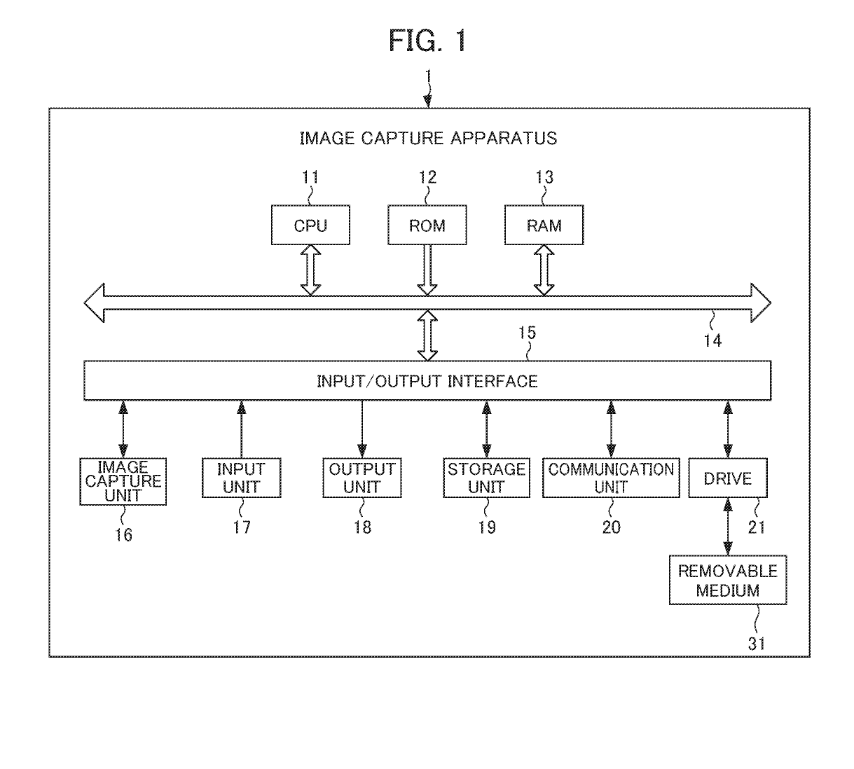

FIG. 1 is a block diagram showing the hardware configuration of an image capture apparatus according to an embodiment of the present invention.

The image capture apparatus 1 is configured as, for example, a digital camera.

The image capture apparatus 1 includes a CPU (Central Processing Unit) (processor) 11, ROM (Read Only Memory) 12, RAM (Random Access Memory) 13, a bus 14, an input/output interface 15, an image capture unit 16, an input unit 17, an output unit 18, a storage unit 19, a communication unit 20, and a drive 21.

The CPU 11 executes various processing according to programs that are recorded in the ROM 12, or programs that are loaded from the storage unit 19 to the RAM 13.

The RAM 13 also stores data and the like necessary for the CPU 11 to execute the various processing, as appropriate.

The CPU 11, the ROM 12 and the RAM 13 are connected to one another via the bus 14. The input/output interface 15 is also connected to the bus 14. The image capture unit 16, the input unit 17, the output unit 18, the storage unit 19, the communication unit 20, and the drive 21 are connected to the input/output interface 15.

The image capture unit 16 includes an optical lens unit and an image sensor, which are not shown.

In order to photograph a subject, the optical lens unit is configured by a lens such as a focus lens and a zoom lens for condensing light.

The focus lens is a lens for forming an image of a subject on the light receiving surface of the image sensor. The zoom lens is a lens that causes the focal length to freely change in a certain range.

The optical lens unit also includes peripheral circuits to adjust setting parameters such as focus, exposure, white balance, and the like, as necessary.

The image sensor is configured by an optoelectronic conversion device, an AFE (Analog Front End), and the like.

The optoelectronic conversion device is configured by a CMOS (Complementary Metal Oxide Semiconductor) type of optoelectronic conversion device and the like, for example. Light incident through the optical lens unit forms an image of a subject in the optoelectronic conversion device. The optoelectronic conversion device optoelectronically converts (i.e. captures) the image of the subject, accumulates the resultant image signal for a predetermined time interval, and sequentially supplies the image signal as an analog signal to the AFE.

The AFE executes a variety of signal processing such as A/D (Analog/Digital) conversion processing of the analog signal. The variety of signal processing generates a digital signal that is output as an output signal from the image capture unit 16.

Such an output signal of the image capture unit 16 is hereinafter referred to as “data of a captured image”. Data of a captured image is supplied to the CPU 11, an image processing unit (not illustrated), and the like as appropriate.

The input unit 17 is configured by various buttons and the like, and inputs a variety of information in accordance with instruction operations by the user.

The output unit 18 is configured by the display unit, a speaker, and the like, and outputs images and sound.

The storage unit 19 is configured by DRAM (Dynamic Random Access Memory) or the like, and stores data of various images.

The communication unit 20 controls communication with other devices (not shown) via networks including the Internet.

A removable medium 31 composed of a magnetic disk, an optical disk, a magneto-optical disk, semiconductor memory or the like is installed in the drive 21, as appropriate. Programs that are read via the drive 21 from the removable medium 31 are installed in the storage unit 19, as necessary. Similarly to the storage unit 19, the removable medium 31 can also store a variety of data such as the image data stored in the storage unit 19.

The image capture apparatus 1 configured as above has a function that enables to create an animation character image in which a photographed person is made into an animation character from an image in which the face of a person is photographed. Furthermore, an animation character image created in the image capture apparatus 1 is created to correspond to a certain theme such as an emotion. In other words, an animation character is created based on an image in which the face of a person is photographed and, furthermore, an animation character is created by adding a theme such as an emotion. In the present embodiment, a theme decides an overall impression of an animation character's image and expresses emotions such as “happy”, “laughing”, “angry”, “crying”, “surprise”, “calm”, “pleading”, “sad”, etc.

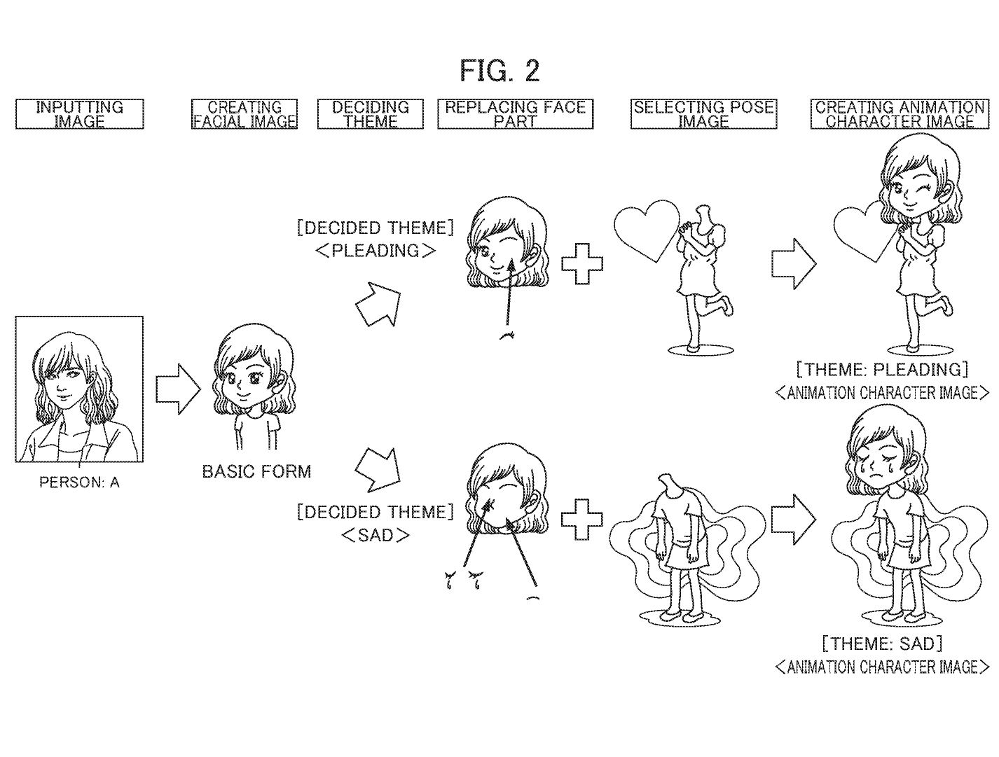

FIG. 2 is a view for explaining a method of creating an animation character image according to the present embodiment.

As illustrated in FIG. 2, regarding an animation character image in the present embodiment, firstly, a facial image (not-actually-photographed image, non-photographic image) which becomes a basic form is created from an actually photographed image (actually-photographed image, photographic image) including the face of a person.

Then, a theme (subject) is decided, and a part region (partial region) of a face in the facial image of the basic form is replaced with an image including a face part (hereinafter, referred to as “not-actually photographed partial image”) so as to correspond to the theme decided. In other words, since the facial image thus created has one kind of facial expression, if the facial image thus created is composited as it is with a pose image (body image) representing emotion, for example, since an animation character image will be created which does not agree between a body expression and a facial expression, the face part is replaced with another corresponding to the theme (not-actually-photographed subject image).

Furthermore, a pose image corresponding to the theme is selected.

It should be noted that a shared image is used for both a not-actually-photographed partial image (not-actually-photographed subject image) and a pose image in the present embodiment. In other words, the identical image is used for a non-actually-photographed partial image (not-actually-photographed subject image) and a pose image also when an animation character image is created for a different target.

Thereafter, the facial image in which a face part is replaced with another corresponding to the theme thus decided is composited with the pose image thus selected so as to make an animation character image (composite image).

The animation character image (composite image) is made by combining the face image (not-actually-photographed subject image) created by the face part image (not-actually-photographed partial image) of the face image, which becomes a basic form, being substituted by the face part image (not-actually-photographed subject image) corresponding to the theme thus decided with the pose image (body image) corresponding to the theme.

More specifically, in a case of the theme of “pleading” being decided to select, a facial image is changed to another having eyes giving a wink as the face part which corresponds to “theme: pleading” so as to composite with a corresponding pose image, a result of which an animation character image having a pose of “pleading” is created.

Furthermore, in a case of the theme of “sad” being decided to select, a facial image is changed to another having eyes and a mouth as the face part which correspond to “theme: sad” so as to composite with a corresponding pose image, a result of which an animation character image having a pose of “sad” is created.

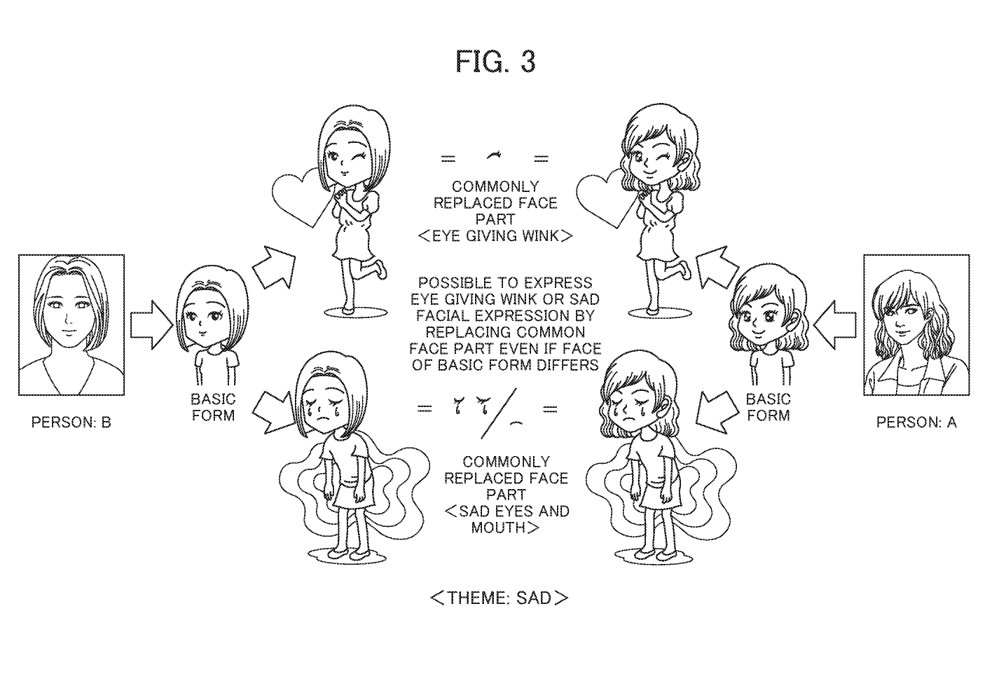

FIG. 3 is a view illustrating a comparative example of an animation character image in a case of creating with a person B different from a person A.

When creating an animation character image from an image of another person who is a person B different from a person A with the abovementioned method, as illustrated in FIG. 3, even if the image has the identical pose, the overall impression differs and the image has an effect of a different animation character image.

Practically, a theme is shared and a shared face part is merely replaced (an eye giving a wink in the case of the theme of “please” and sad eyes and a mouth in the case of the theme of “sad”). However, since the shapes such as of a hair style, eyes, a mouth, and eyebrows will differ, it is recognized as another person. In other words, the face part replaced does not affect a person's identity. In other words, in both animation character images, the face parts are replaced using the same images of eyes giving a wink, sad eyes, and a sad mouth. However, the animation character images give impressions as if the facial images of the basic forms change to the respective facial expressions. Regarding the face parts to be replaced in an illustration form, a form of eyes when smiling can be expressed as an illustration in an arc-shape in an upwards direction, a form of eyes when crying can be expressed as an illustration in an arc-shape in a downwards direction, a form of a mouth when laughing can be expressed as an illustration in a shape of opening widely, and a form of a mouth when sad can be expressed as an illustration in an arc-shape in an upwards direction. Therefore, regardless of parts in illustration forms of original faces, it is possible to change facial expressions by preparing replacement parts for laughing, wink, and crying, one by one, respectively, and simply replacing therewith.

Furthermore, since the parts thus replaced do not correspond to each person but are the same face parts, it is unnecessary to prepare special face parts.

Therefore, in the image capture apparatus 1, it is possible to create an animation character image corresponding to a theme easily by simply replacing face parts. Furthermore, it is also possible to reduce a data volume for image creation since a replacement target is by a face part unit and, furthermore, a shared image is used for the non-actually-photographed partial image (not-actually-photographed subject image) and a pose image regardless of the target.

Furthermore, in the image capture apparatus 1, since facial parts other than the face parts are created based on an actually-photographed image, an animation character image can be made which can be identified as a different animation character image although the non-actually-photographed partial image (not-actually-photographed subject image) and the pose image are the same.

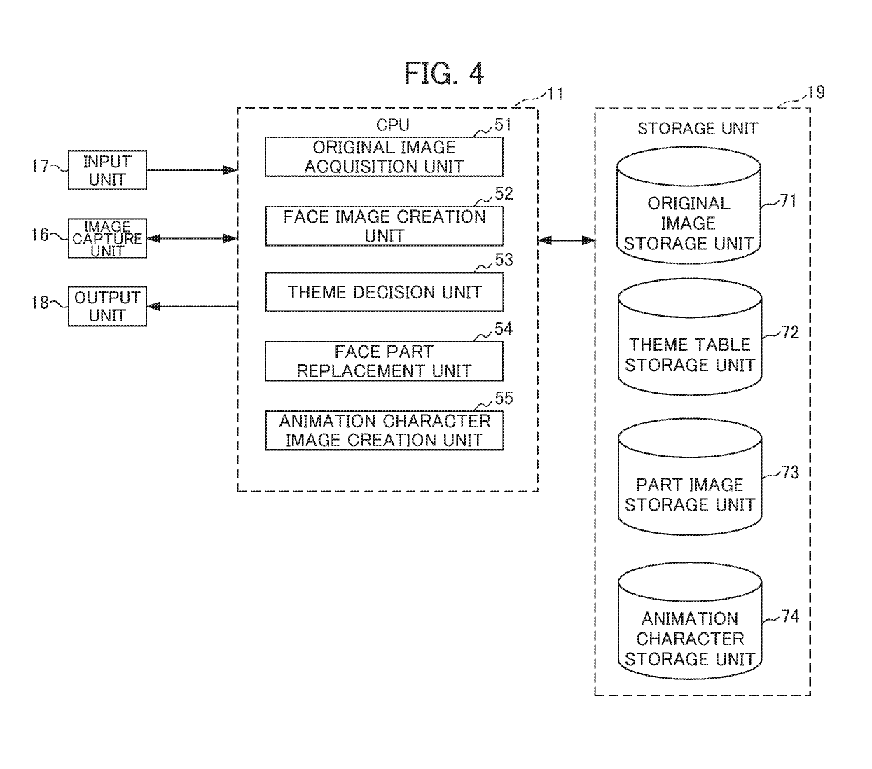

FIG. 4 is a functional block diagram showing a functional configuration for executing animation character image creation processing, among the functional configurations of the image capture apparatus 1.

The animation character image creation processing refers to a sequence of processing of replacing a facial image created from an original image (actually-photographed image) with a face part corresponding to a theme, compositing with a pose image corresponding to the theme, and creating an animation character image.

In a case of executing the animation character creation processing, as illustrated in FIG. 4, an original image acquisition unit 51, a facial image creation unit 52, a theme decision unit 53, a face part replacement unit 54, and an animation character creation unit 55 function in the CPU 11.

Furthermore, an original image storage unit 71, a theme table storage unit 72, a part image storage unit 73, a character image storage unit 74 are set in a region of the storage unit 19.

In the original image storage unit 71, data of images (original images as processing targets) acquired from the image capture unit 16 or via the Internet externally are stored. In the present embodiment, data of an actually-photographed image in which the face of a person is photographed is stored.

A theme table in which a theme and a face part are associated is stored in the theme table storage unit 72.

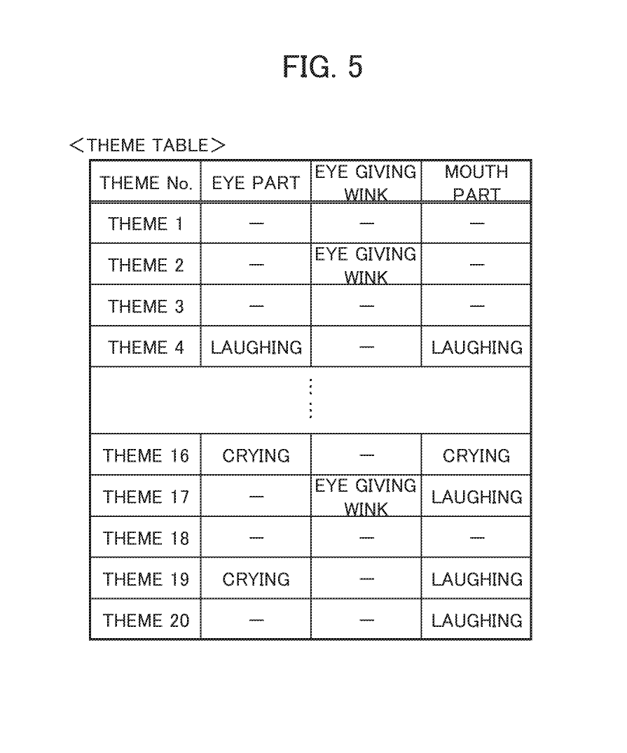

FIG. 5 is a schematic view for explaining a theme table stored in the theme table storage unit 72.

As illustrated in FIG. 5, the theme table is a table in which theme numbers (“Theme No.”) corresponding to contents of poses are associated with a state of each face part (“eye part” indicating a state of eyes, “wink” indicating whether or not giving a wink, and “mouth part” indicating a state of a mouth) and image data of each face part (not-actually-photographed subject image). “Eye part: smiling/crying” indicates selecting a not-actually-photographed partial image (not-actually-photographed subject image) of Eye part: smiling/crying among the face parts, “wink: wink” indicates a wink being given in the eyes among the face parts and selecting a not-actually photographed partial image (not-actually-photographed subject image) of a wink, and “mouth part: smiling/crying” indicates selecting a not-actually photographed partial image (not-actually-photographed subject image) of mouth part: smiling/crying among the face parts.

Data of the not-actually photographed partial image and data of various part images used for creating an animation character image such as a pose image corresponding to a theme are stored in the part image storage unit 73.

Here, the “not-actually photographed partial image” is an image corresponding to a facial part such as eyes, a mouth, an eye (an eye giving a wink) as illustrated in FIGS. 2 and 3, for example, and a shared image regardless of a face image as a target.

Furthermore, in the present embodiment, the “pose image” includes a body other than a face as illustrated in FIGS. 2 and 3, and includes a background image corresponding to a theme.

In the animation character image storage unit 74, data of an animation character image created is stored.

The original image acquisition unit 51 acquires an original image as a target for creating a facial image stored in the original image storage unit 71 based on an operation of selecting an image through the input unit 17 by a user.

The face image creation unit 52 creates a facial image based on a facial region of an original image acquired by the original image acquisition unit 51. Since the replacement of a face part is not performed, the facial image created from the original image is a facial image in a basic form.

The theme decision unit 53 decides a theme based on a theme decision operation via the input unit 17 by a user. In the present embodiment, the theme decided by the theme decision unit 53 is a pose that expresses a person's emotion such as “happy”, “laughing”, “angry”, “crying”, “surprised”, “calm” and “pleading”.

With reference to a theme table stored in the theme table storage unit 72 based on the theme decided by the theme decision unit 53, the face part replacement unit 54 replaces a corresponding not-actually-photographed partial image (not-actually-photographed subject image) stored in the part image storage unit 73 with a face part of a facial image. As a result of the replacement of a face part of the facial image by way of the face part replacement unit 54, a facial image corresponding to the theme (hereinafter, referred to as “theme-corresponding facial image”) is created.

The animation character creation unit 55 composites the theme-corresponding facial image created by the facial image creation unit 52 and the face part replacement unit 54 with a pose image corresponding to a theme stored in the part image storage unit 73 so as to create an animation character image.

The part image storage unit 73 causes the animation character image thus created to be stored in the animation character image storage unit 74 and to be displayed and outputted to the output unit 18.

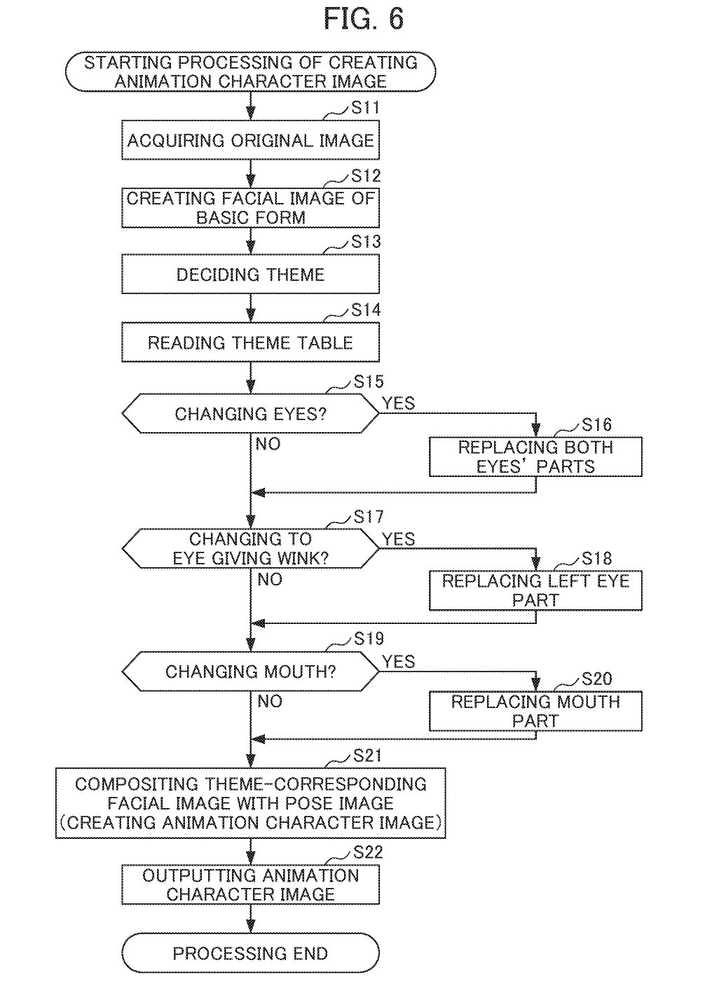

FIG. 6 is a flowchart illustrating a flow of animation character image creation processing executed by the image capture apparatus 1 of FIG. 1 having the functional configuration of FIG. 4.

The animation character image creation processing starts by an operation of starting the animation character image creation processing on the input unit 17 by a user.

In Step S11, the original image acquisition unit 51 acquires an original image as a target for creating a facial image from the original image storage unit 71 based on an operation of selecting an image via the input unit 17 by a user.

In Step S12, the facial image creation unit 52 creates a facial image (a facial image in a basic form) based on a facial region of the original image acquired by the original image acquisition unit 51 (the step of creating a not-actually-photographed image).

In Step S13, the theme decision unit 53 decides a theme based on an operation of deciding a theme via the input unit 17 by a user. More specifically, the theme decision unit 53 decides one pose from among “laughing”, “angry”, “crying”, “surprised” and “calm”. More specifically, the theme decision unit 53 decides the theme of “laughing” from among the themes of “laughing”, “angry”, “surprised” and “calm”.

In Step S14, the face part replacement unit 54 reads a theme table corresponding to the theme decided by the theme decision unit 53 from the theme table storage unit 72. More specifically, the face part replacement unit 54 reads a part table corresponding to the pose of “laughing” from the theme table storage unit 72.

In Step S15, the face part replacement unit 54 judges whether the eyes are changed based on the theme table thus read.

In a case in which the eyes are not changed, it is judged as NO in Step S15, and the processing advances to Step S17. Processing after Step S17 will be described later.

In a case in which eyes are changed, it is judged as YES in Step S15, and the processing advances to Step S16.

In Step S16, the face part replacement unit 54 replaces an eye part of the facial images with an eye part image stored in the part image storage unit 73 (the step of changing).

In Step S17, the face part replacement unit 54 judges whether to change to eyes giving a wink.

In a case of not changing to eyes giving a wink, it is judged as NO in Step S17, and the processing advances to Step S19.

In a case of changing to eyes giving a wink, it is judge as YES in Step S18, and the processing advances to Step S18.

In Step S18, the face part replacement unit 54 replaces an eye part corresponding to eyes giving a wink among the facial parts with an eye part image stored in the part image storage unit 73, based on the theme table (step of changing).

In Step S19, the face part replacement unit 54 judges whether to change a mouth.

In a case of not changing a mouth, it is judged as NO in Step S19, and the processing advances to Step S21.

In a case of changing a mouth, it is judged as YES in Step S19, and the processing advances to Step S20.

In Step S20, the face part replacement unit 54 replaces a mouth part of the facial images with a not-actually-photographed partial image (not-actually-photographed subject image) of a mouth stored in the part image storage unit 73, based on the theme table (step of changing). As a result of all of the face parts being replaced based on the theme table, a facial image corresponding to a pose is created.

In Step S21, the animation character image creation unit 55 composites a pose image corresponding to a theme decided by the theme decision unit 53 with a face image corresponding to a pose created by the face part replacement unit 54 so as to create an animation character image (step of creating a composite image).

In Step S22, the animation character image creation unit 55 causes an animation character image thus created to be stored in the animation character image storage unit 74 and to be displayed and outputted to the output unit 18. Thereafter, the animation character image creation processing ends.

Therefore, a theme table in which a pose image corresponds to a not-actually-photographed partial image (not-actually-photographed subject image) to be changed is prepared for each theme and a face part that matches an emotion that expresses a theme depending on the theme is replaced so that the emotion of the pose image matches the emotion of the face. A face part of an eye part in an arc-shape in an upward direction and a face part of an eye part in an arc-shape in a downward direction in a state of the eyes being closed are prepared and a face part of a mouth in a state of the mouth being open and a face part of a mouth in a state of the mouth being in the form of “̂” are prepared. Then, by combining them to replace original face parts, it is possible to change to various facial expressions. Therefore, it becomes possible to composite a facial image in which facial parts are replaced with various poses, and it is possible to create a variety of animation character images. Since the face part of an eye, the face part of a mouth, and a minimum number of parts for replacement can be applied to any facial image, the capacity for storing the not-actually-photographed partial image is not pressed.

The image capture apparatus 1 configured as above includes the original image acquisition unit 51, the facial image creation unit 52, the theme decision unit 53, the face part replacement unit 54, and the animation character creation unit 55.

The original image acquisition unit 51 acquires an original image as a target for processing.

The facial image creation unit 52 creates a facial image which is a first image based on a characteristic region of the original image acquired by the original image acquisition unit 51.

The theme decision unit 53 decides a theme which is a subject of an image to be created.

The facial image creation unit 52 changes the face image which is the first image, based on a theme which is a subject of an image to be created decided by the theme decision unit 53.

The animation character image creation unit 55 creates a pose image, which is a second image corresponding to the facial image that is the first image, based on the theme which is the subject of the image to be created decided by the theme decision unit 53.

The animation character image creation unit 55 composites the facial image, which is the first image changed by the face part replacement unit 54, with the pose image that is the second image created by the animation character creation unit 55 so as to create an animation character image which is a third image.

With such a configuration, in the image capture apparatus 1, it is possible to create animation character images that express various expressions of animation characters with less data volume.

The face part replacement unit 54 changes a partial image that constitutes the facial image which is the first image based on a theme which is a subject of an image to be created decided by the theme decision unit 53.

With such a configuration, in the image capture apparatus 1, it is possible to create various animation character images.

Furthermore, in the image capture apparatus 1, an original image is an actually-photographed image including a face.

The facial image creation unit 52 sets a characteristic region as a facial region from the original image and creates a facial image which is the first image based on the facial region.

The face part replacement unit 54 changes a partial region as a portion constituting a face as a unit among the facial images which is the first image.

With such a configuration, in the image capture apparatus 1, for example, since the change is performed in part units that constitute a face such as eyes and a mouth, for example, the change can be performed easily.

The image capture apparatus 1 includes the part image storage unit 73 that stored a not-actually-photographed partial image (not-actually-photographed subject image) which is an image of each part constituting a face corresponding to a theme which is a subject of an image to be created.

The face part replacement unit 54 changes an image of a corresponding portion and a partial region of a face based on the theme which is the subject of the image to be created decided by the theme decision unit 53.

With such a configuration, in the image capture apparatus 1, the time and labor for creating a non-actually-photographed partial image are reduced by using a pose image corresponding to a theme stored in advance, and it is possible to reduce the data volume for image creation.

The animation character image creation unit 55 creates an image including a body corresponding to a face as a pose image which is a second image.

Since a portion other than a face is created in the image capture apparatus 1, it is thereby possible to create animation character images with various expressions.

The part image storage unit 73 stores a pose image which is the second image corresponding to a theme that is a subject of an image to be created.

The animation character image creation unit 55 acquires a pose image which is the corresponding second image from the part image storage unit 73, based on the theme which is the subject of the image to be created decided by the theme decision unit 53.

In the image capture apparatus 1, the time and labor for creating a pose image are reduced by using a pose image corresponding to a theme stored in advance, and it is possible to reduce the data volume for image creation.

A theme that is a subject of an image to be created is a theme that expresses a person's emotion.

In the image capture apparatus 1, it is thereby possible to create animation character images with various expressions.

It should be noted that the present invention is not to be limited to the aforementioned embodiments, and that modifications, improvements, etc. within a scope that can achieve the objects of the present invention are also included in the present invention.

Although it is configured so that the pose image includes the body other than the face and the background image in the abovementioned embodiment, the pose image may be acceptable so long as it is configured to express a theme as well as a face image. Therefore, for example, a pose image including a body other than a face, a pose image including only the upper half of the body, and a pose image to which a background image is added may be acceptable.

Furthermore, although a user performs a theme decision in the abovementioned embodiment, it may also be configured to perform a theme decision using a judgment result of a facial expression of an original image, for example. Furthermore, the theme that is the subject is not limited to a person's emotion, and thus the theme may be an action, a posture, a behavior, etc.

In the aforementioned embodiments, explanations are provided with the example of the image capture apparatus 1 to which the present invention is applied being a digital camera; however, the present invention is not limited thereto in particular.

For example, the present invention can be applied to any electronic device in general having an animation image creation processing function. More specifically, for example, the present invention can be applied to a laptop personal computer, a printer, a television receiver, a video camera, a portable navigation device, a cell phone device, a smartphone, a portable gaming device, and the like.

The processing sequence described above can be executed by hardware, and can also be executed by software.

In other words, the hardware configurations of FIG. 4 are merely illustrative examples, and the present invention is not particularly limited thereto. More specifically, the types of functional blocks employed to realize the above-described functions are not particularly limited to the examples shown in FIG. 4, so long as the image capture apparatus 1 can be provided with the functions enabling the aforementioned processing sequence to be executed in its entirety.

A single functional block may be configured by a single piece of hardware, a single installation of software, or a combination thereof.

In a case in which the processing sequence is executed by software, the program configuring the software is installed from a network or a storage medium into a computer or the like.

The computer may be a computer embedded in dedicated hardware. Alternatively, the computer may be a computer capable of executing various functions by installing various programs, e.g., a general-purpose personal computer.

The storage medium containing such a program can not only be constituted by the removable medium 31 of FIG. 1 distributed separately from the device main body for supplying the program to a user, but also can be constituted by a storage medium or the like supplied to the user in a state incorporated in the device main body in advance. The removable medium 31 is composed of, for example, a magnetic disk (including a floppy disk), an optical disk, a magnetic optical disk, or the like. The optical disk is composed of, for example, a CD-ROM (Compact Disk-Read Only Memory), a DVD (Digital Versatile Disk), Blu-ray (Registered Trademark) or the like. The magnetic optical disk is composed of an MD (Mini-Disk) or the like. The storage medium supplied to the user in a state incorporated in the device main body in advance is constituted by, for example, ROM in which the program is recorded or a hard disk, etc. included in the storage unit.

It should be noted that, in the present specification, the steps defining the program recorded in the storage medium include not only the processing executed in a time series following this order, but also processing executed in parallel or individually, which is not necessarily executed in a time series.

The embodiments of the present invention described above are only illustrative, and are not to limit the technical scope of the present invention. The present invention can assume various other embodiments. Additionally, it is possible to make various modifications thereto such as omissions or replacements within a scope not departing from the spirit of the present invention. These embodiments or modifications thereof are within the scope and the spirit of the invention described in the present specification, and within the scope of the invention recited in the claims and equivalents thereof.

What is claimed is:

1. An image creation method executed by a control unit, comprising the steps of:
creating a not-actually-photographed face image of a face based on an actually-photographed image including the face acquired in the actually-photographed image;
changing, based on a subject, at least one of a plurality of not-actually-photographed partial images which respectively correspond to a plurality of partial regions of the not-actually-photographed face image, to a not-actually-photographed subject image corresponding to a subject; and
making a composite image by combining a body image based on the subject and the not-actually-photographed face image, wherein the not-actually-photographed face image refers to a not-actually photographed face image in which at least one of the not-actually-photographed partial images has been substituted by a not-actually-photographed subject image.

2. The image creation method according to claim 1, wherein
the step of changing changes an image of the partial region of the not-actually-photographed image with a portion constituting the face as a unit.

3. The image creation method according to claim 1, wherein
the step of changing selects at least one not-actually-photographed partial image corresponding to the subject from among a plurality of not-actually-photographed partial images corresponding to the subject from among a plurality of not-actually-photographed partial images which are images of each portion constituting a face and corresponds to the subject, and changes an image of the partial region of the not-actually-photographed image which corresponds to the not-actually-photographed image selected.

4. The image creation method according to claim 1, wherein
the body image is an image that expresses a posture or a behavior of a person.

5. The image creation method according to claim 1, wherein
the control unit performs at least one the body image based on the subject from among a plurality of the body images.

6. The image creation method according to claim 5, wherein
the step of selecting selects at least the one body image based on the subject selected by a user from among the plurality of the body images.

7. The image creation method according to claim 1, wherein
the subject expresses at least one of a person's emotion, action, posture, and behavior.

8. The image creation method according to claim 3, wherein
the not-actually-photographed partial image corresponding to the subject is the not-actually-photographed subject image.

9. A computer-readable storage medium that controls an image creation apparatus including a control unit to perform:
a step of creating a not-actually-photographed face image of a face based on an actually-photographed image including the face acquired in the actually-photographed image;
a step of changing, based on a subject, at least one of not-actually-photographed partial image among a plurality of not-actually-photographed partial images which respectively correspond to a plurality of partial regions of the not-actually-photographed face images, to a not-actually-photographed subject image corresponding to a subject, based on the subject; and
a step of making a composite image by combining a body image based on the subject and the not-actually-photographed face image, wherein the not-actually-photographed face image refers to a not-actually photographed face image in which at least one of the not-actually-photographed partial images has been substituted by a not-actually-photographed subject image.

10. An image creation apparatus comprising a control unit,
wherein the control unit is configured to perform:
creating a not-actually-photographed face image of a face based on an actually-photographed image including the face acquired in the actually-photographed image;
changing, based on a subject, at least one of not-actually-photographed partial image among a plurality of not-actually-photographed partial images which respectively correspond to a plurality of partial regions of the not-actually-photographed face image, to a not-actually-photographed subject image corresponding to a subject; and
making a composite image by combining a body image based on the subject and the not-actually-photographed face image, wherein the not-actually-photographed face image refers to a not-actually photographed face image in which at least one of the not-actually-photographed partial images has been substituted by a not-actually-photographed subject image.

11. The image creation apparatus according to claim 10, further comprising:
a storage unit that stores a plurality of not-actually-photographed partial images which are images of each portion constituting a face and corresponding to the subject.

12. The image creation apparatus according to claim 10,
wherein the storage unit stores a plurality of body images corresponding to the subject.

13. The image creation apparatus according to claim 9,
wherein one or more of the storage unit is provided.

14. The image creation apparatus according to claim 10,
wherein types of the subject includes a plurality of types, and
wherein the storage unit stores the plurality of body images according to a plurality of subjects.

15. The image creation apparatus according to claim 10,
wherein the image creation apparatus is a small device.
